(19) United States
(12) Patent Application Publication
(10) Pub. No.: US 2019/0367361 A1
(43) Pub. Date: Dec. 5, 2019

(54) Automatic Optimization Of An Ozone Generating Device

(71) Applicant: David J. Krause, Yreka, CA (US)

(72) Inventor: David J. Krause, Yreka, CA (US)

(21) Appl. No.: 16/393,130

(22) Filed: Apr. 24, 2019

Related U.S. Application Data
(60) Provisional application No. 62/762,934, filed on May 29, 2018.

(51) Int. Cl. C01B 13/11; H01T 19/00; G05B 19/042

(52) U.S. Cl. CPC C01B 13/115; C01B 2201/90; G05B 19/0425; H01T 19/00

(57) ABSTRACT

An automatic optimization of an ozone generating device with a control PC board that controls a corona discharge cell via a microprocessor. An alarm, conveyed through a diagnostic LED, show how the cell is performing. The microprocessor is programmed to monitor current draw, transformer input voltage and length of time of use of the corona discharge cell. LED diagnostic indicator lights give a twelve function diagnostic ability including showing if the generating device is turned off; if the generating device is powered but the pilot input is off; the time between when the pilot input is supplied with voltage and the high voltage finally turns on; the high voltage output is on and stable; the auxiliary output signal lines normally closed or normally open are shorted; the programmed maintenance time has expired.

### CLAIMED PROVISIONAL PATENT APPLICATION

U.S. Provisional patent application No. 62/762,934 filed May 29, 2019 is claimed as priority application and is incorporated here within.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of electronic control devices and more specifically to an automatic optimization of an ozone generating device.

Ozone generators are well known and typically used taking impurities out of water or air. Basically, a corona discharge cell is powered by high voltage and creates the molecule O3 which is unstable by nature and in response to this instability, seeks to attract extraneous partials from the air or water, and in the process, destroys the extraneous partials which may be unwanted pollutants or waterborne bacteria. Although corona discharge cells have been in existence for many years, there are issues with keeping the generators in optimum working condition.

Existing ozone generators have manual potentiometer tuning ability. This feature is helpful but not as comprehensive as needed for prolonged life and optimum operation conditions. Existing ozone generators do not have programmable microcontrollers that allow the user to set frequency or set on-delay timing for high voltage and signal outputs or set under current limits for normal high voltage operation or set clock timers adjustments.

Additionally, current ozone generators do not have programmable microcontrollers that allow the user to set frequency or set on-delay timing for high voltage and signal outputs or set under-current limits for normal high voltage operation or set clock timers adjustments. A generator that includes the above listed features will last longer and operate more efficiently.

### BRIEF SUMMARY OF THE INVENTION

The primary object of the invention is to provide automatic optimization of an ozone generating device.

Another object of the invention is to provide a diagnostic LED to let the user know the efficiency of the ozone generating device.

Another object of the invention is to provide a power optimized circuit for automatic or manual voltage adjustment.

A further object of the invention is to provide programmable features to adjust on/off delay, frequency adjustment, and an alarm to remind the user when to clean or replace the corona discharge cell.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an automatic optimization of an ozone generating device comprising: a control PC board, a corona discharge cell, a microprocessor, an alarm component, a diagnostic LED, an alarm reset switch, a high voltage transformer and a terminal block, said microprocessor programmed to monitor current draw and transformer input voltage, and said microprocessor including a timing circuit to record length of time in use of said corona discharge cell.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a top plan view of the PC board of the present invention.

FIG. 2 is a bottom plan view of the PC board of the present invention.

FIG. 3 is a schematic diagram of the microprocessor of the present invention.

FIG. 4 is a of the discharge cell and transformer and associated electrical components.

FIG. 5 is a diagram of the terminal block.

### DETAILED DESCRIPTION OF THE DRAWINGS AND PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

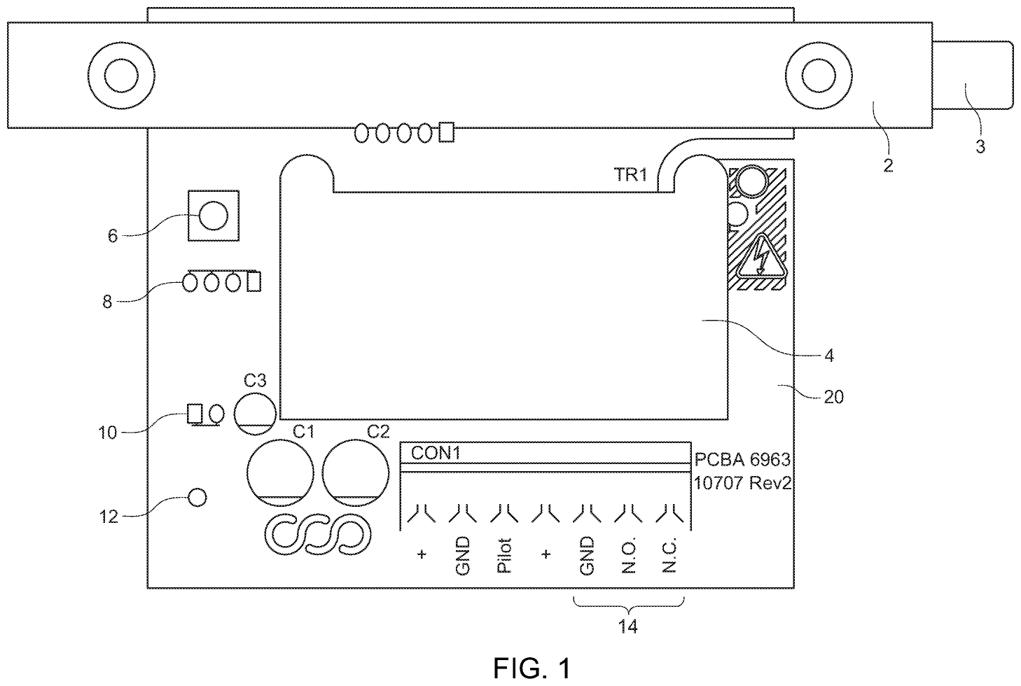

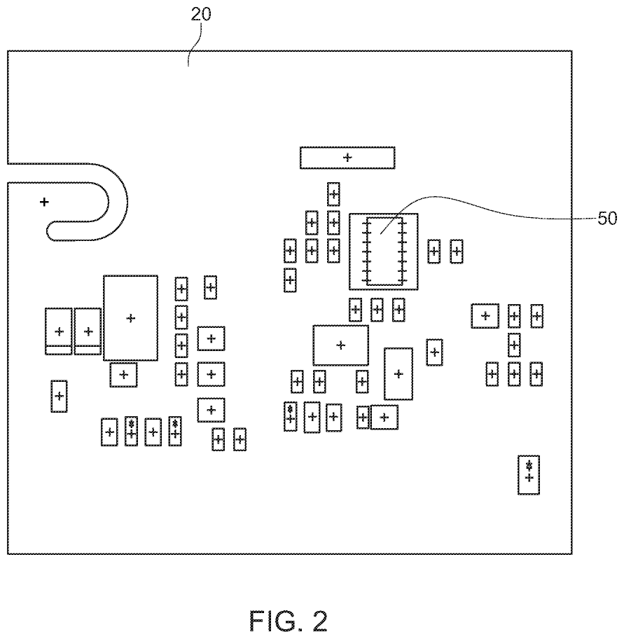

Referring now to FIG. 1 we see a top plan view of the printed circuit board 20 for the present invention. A corona discharge cell 2, also revered to as a CD cell, or the cell, is wired via cell tip 3 to a high voltage transformer 4. A microprocessor 50, preferably model PIC16F882-IO/SS″, is located on the bottom side of the PC board 20 as shown in FIG. 2 and controls a diagnostic LED 12. An alarm reset switch 6 can be pressed by the user once an alarm situation has been resolved. The corona discharge cell 2 is made of stainless steel and is serviceable. Over time nitric acid can build up inside the cell 2 which can render the unit faulty. Because the cell 2 can be cleaned with warm water and compressed air, the cell 2 can be flushed of contaminants which can extend its life before replacement is needed. Terminal block 14 connects the PC board to external potentiometer 10 which allows the user to manually adjust HV transformer 4 operating frequency which, in-turn, adjusts ozone output. A serial port 8 allows the present invention to be connected to external devices such as a computer. Alarm reset button 6 allows the user to reset the LED function after an unwanted situation has been rectified.

The present invention works in the following way:

Utilizing low voltage, which conserves electricity as opposed to 115/230 VAC units, the power optimized circuit adjusts and controls the amperage and frequency to optimize ozone output. Over time, environmental conditions may change which may have an adverse effect on the efficiency of the ozone producing cell 2. The optimization circuit of the present invention has a preset programmable setting in which it will adjust operating frequency, which in turn relates to current draw, which acts to maintain high ozone output when conditions such as, humidity, wear and tear, temperature, pressure and many other external factors change.

The diagnostic indicator light 12 function helps to diagnose the status of the unit at any given time. The functions are specifically designed to measure circuit characteristics and display the status. This improves service functions and communication of efficiency status. The indicator lights can help to indicate whether a short has been detected within the electronics as well as indicating it is time to service the unit. The service time is also programmable so that it can be adjusted for the appropriate length of time based on the usage and application.

The present invention monitors operating frequencies fifteen times per second within the high voltage transformer 4, and adjusts the frequency as needed. This feature attempts to automatically keep the transformer 4 operating at its resonant frequency. Users can view frequency changes demonstrated by an occasional red flash from the on-board LED 12

By operating at its resonant frequency, the transformer 4 can more efficiently power the corona discharge cell 2, resulting in less energy expended to heat waste, as previous designs have allowed. Additionally, adjustment of the operating frequency can compensate for changes in CD cell load, and temperature. A resonant mode flyback topology is a very inexpensive way to generate high voltage. Other topologies can be more efficient or more powerful but they cost significantly more. “Automatic mode” keeps the transformer at its maximum efficiency which transfers as much power as the cell is capable of accepting. This feature is advantageous to users because it maximizes ozone output in real time. By optimizing operating frequency, the user may experience longer service intervals, and improved ozone production performance over a longer service period than with other generators that may deteriorate more quickly.

A manual mode is also available in the present invention. The manual feature is the opposite of the automatic frequency adjusting/power optimized feature. When the external potentiometer 10 is connected, the PCB and microprocessor 20 automatically recognizes the connection and internally switches to manual mode. When the potentiometer is connected 10, the user may adjust the operating frequency throughout the full range. When frequency is adjusted, current draw from the transformer 4 is altered, and the ozone production rate is changed accordingly. Higher frequencies draw more current through the cell, therefore creating more ozone. The inverse operation is also true.

A third operating mode is also included in the present invention where the operating frequency may be fixed as a programmable option. The fixed frequency mode constrains the transformer to operate at a discrete value, rather than adjust automatically as previously described in “automatic mode”.

The fixed frequency feature allows users that have power limitations lower than the resonant frequency of the transformer 4 to still use the present PCB 20 and included electrical components. The external potentiometer feature allows the user to manually adjust operating frequency, on the fly, without reprogramming the microprocessor 50. By giving the user the opportunity to change operating frequencies through the use of the external potentiometer, the application scope broadens. This feature uses a common, 10K Ohm pot and gives the user manual ozone adjustability.

As noted earlier, the present invention includes a diagnostic LED light 12. The LED light 12 is affixed to the PCB and gives the user feedback as to the status of the system. There are twelve different color and flashing sequence variations to alarm the user of potential problems, initiate CD cell cleaning procedures, or assure the generator is working normally. The color (red/green/orange) and flash rate are entirely under software control.

The software can detect a heavily flooded cell by primarily monitoring current draw. It can also detect normal operation by looking at the behavior of the transformer's input voltage while it's cycled on/off.

It can tell the user when a year has passed so periodic maintenance can be performed through the implementation of programmable timer within the circuit.

It tells the user when the high voltage transformer is on/off by flashing at different rates.

It tells the user when the Aux relay signal outputs are shorted by monitoring output voltage.

Every time the frequency has to change, it signals the user with a red blip. This allows the user to keep an eye on how often the operating environment of the cell is changing. When first turned on, there are occasional red blips as the cell and transformer warm up and finds optimum operating frequency. Once the electronics are heat saturated, there are very few blips. The red blips become more frequent as cell conditions rapidly change (air supply gets hot or cold or humid), or the cell starts to get polluted with nitric acid.

This feature allows the user to quickly and confidently diagnose the health of the ozone generator. The LED light 12 enables the user to give real time information to service personnel to aide in troubleshooting, quick repair, or indicate other service is needed. The LED light 12 can reduce the costs of service calls and return the unit back to use quickly by allowing the user or service personnel to diagnose and repair through relayed information.

The present multifunction LED light feature had not been incorporated into any previous ozone generating device. The microprocessor-controlled light 12 offers much more information than a single I/O indicator that is standard on other ozone generators.

The present invention also includes programmable internal circuit configurations. The microcontroller's 50 firmware allows an external serial link access to a few variables for greater flexibility. These configurable settings include: automatic/manual frequency adjust operation modes, on-delay timing for high voltage and signal outputs, under-current limits for normal high voltage operation, and clock timer adjustments. The physical interface is through a USB/RS232 adapter, UART adapter, and a four-pin header 14 mounted to the PCB itself.

Having programmable settings allows the manufacturer to have the internal customizability to tailor ozone generators to their customer's needs. This feature allows greater adjustability than previous designs while providing new opportunity to incorporate the newly designed PCB into a wide range of products. The digital format takes the guesswork out of tuning the PCB by providing discrete values, all while creating a faster, cost saving alternative to traditional manual potentiometer tuning.

This feature is not available or incorporated into other ozone generators. The feature gives greater control of the ozone generator while it provides a faster solution to the end goal of consistent, predictable ozone output.

The microprocessor is programmed to allow nine configurations. They are as follows:

| Location | Name | Description |
|---|---|---|
| 0x00 | Auto_Man | Automatic or manual operation |
| 0x01 | Man_Adjust | Operating set point for manual operation |
| 0x02 | Delay_HV | The on-delay for high voltage output |
| 0x03 | Delay_Sig | The on-delay for signal output (NO & NC) |
| 0x04 | Clock_Min | Minute section of year clock |
| 0x05 | Clock_Hour | Hour section of year clock |
| 0x06 | Clock_Day | Day section of year clock |
| 0x07 | Clock_Month | Month section of year clock |
| 0x08 | Current_Limit | Sets under-current limit for normal HV |
| | | operation |

| Location | Name | Range/Units |
|---|---|---|
| 0x00 | Auto_Man | “M” (4Dh) equates to manual operation. |
| | | Anything else equates to automatic |
| | | operation. |
| 0x01 | Man_Adjust | 0 to 147 (0 to 93 h). |
| 0x02 | Delay_HV | 0 to 255 seconds (4 min 15 sec) |
| 0x03 | Delay_Sig | 0 to 255 seconds (4 min 15 sec) |
| 0x04 | Clock_Min | 0 to 59 |
| 0x05 | Clock_Hour | 0 to 24 |
| 0x06 | Clock_Day | 0 to 30 |
| 0x07 | Clock_Month | 0 to 255 |
| 0x08 | Current_Limit | 0 to 255 (0 to 1.25 A) |

FIG. 2 is a plan view of the underside of PCB 20 which includes a number of electrical components including microprocessor 50

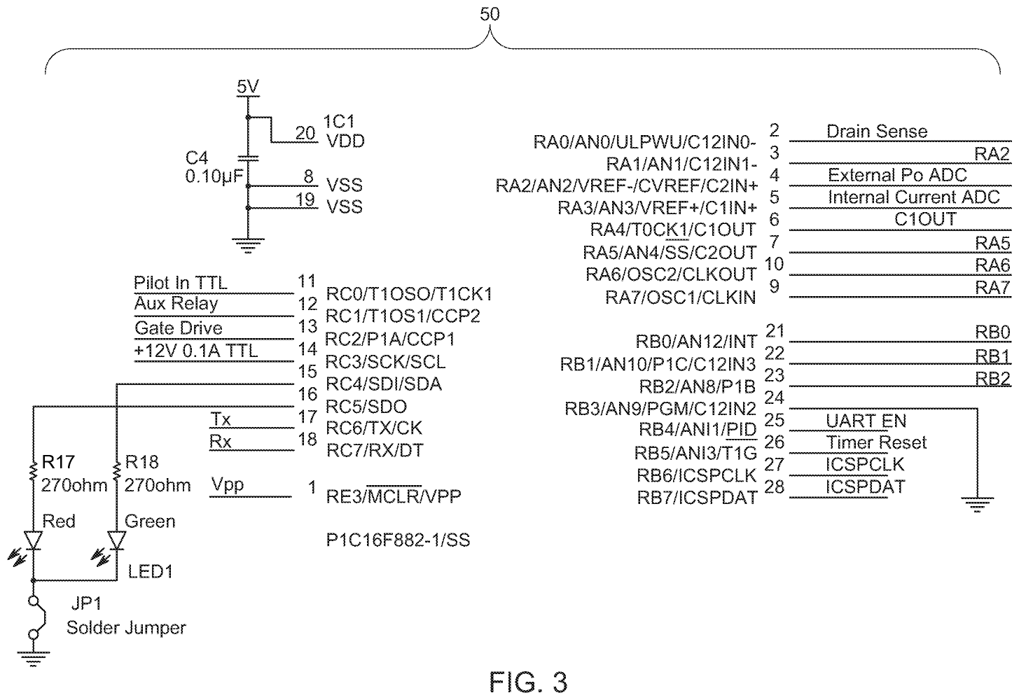

FIG. 3 is a schematic view of the microprocessor 50 showing what each leg is connected to.

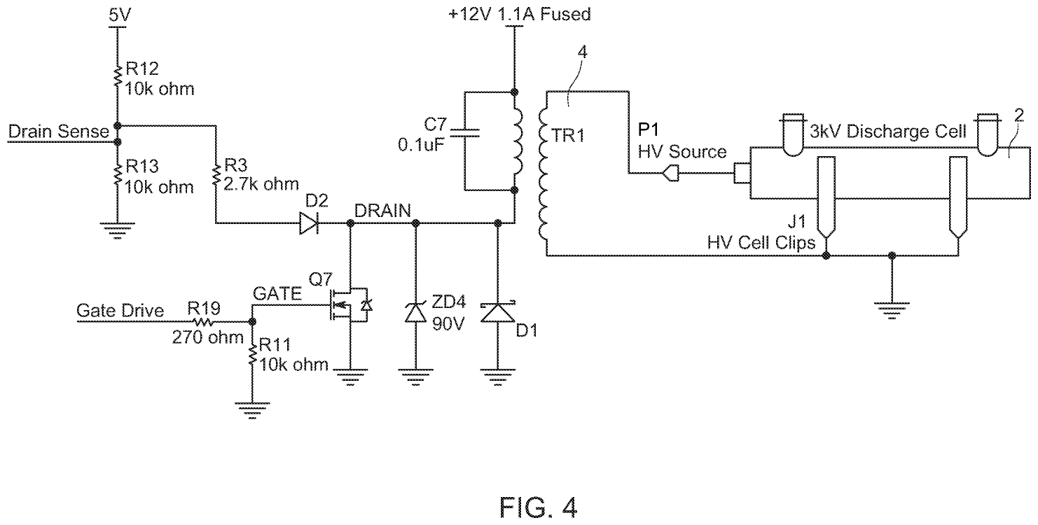

FIG. 4 is a schematic view of the corona discharge cell 2, high frequency transformer 4 and other related electronic components.

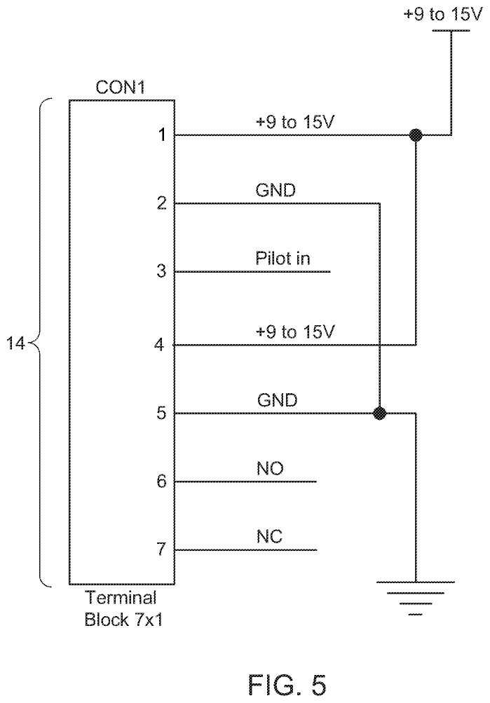

FIG. 5 is a diagram of terminal block 14 showing where each connector point goes to.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Automatic optimization of an ozone generating device comprising:
a control PC board;
a corona discharge cell;
a microprocessor;
an alarm component;
a diagnostic LED;
and alarm reset switch;
a frequency driver;
a terminal block;
a high voltage transformer;
said microprocessor programmed to monitor current draw and said transformer input voltage; and
said microprocessor including a timing circuit to record length of time in use of said corona discharge cell.

2. An automatic optimization of an ozone generating device as claimed in claim 1 wherein said LED diagnostic indicator light includes a twelve-function diagnostic ability including showing if said generating device is turned off if said generating device is powered but the pilot input is off;
The approximately three second time between when the pilot input is supplied with voltage and the high voltage finally turns on;
the high voltage output is on and stable and not under-current;
the high voltage output is stable or unstable.
the auxiliary output signal lines normally closed or normally open are shorted;
The programmed maintenance time has expired.

3. An automatic optimization of an ozone generating device as claimed in claim 1 wherein said alarm can illuminate in different preset colors to tell the user when to clean or replace said corona discharge cell, or recommended system maintenance.

4. An automatic optimization of an ozone generating device as claimed in claim 1 wherein said micro-processor can be programmed to set frequency adjustment or set under-current limit set point or cease high voltage output when a predetermined threshold is reached indicating a flooded cell.
